(19) United States
(12) Patent Application Publication
(10) Pub. No.: US 2004/0153338 A1
(43) Pub. Date: Aug. 5, 2004

(54) Medical information system

(76) Inventors: Back Kim, Lake Success, NY (US); Richard I. Mallah, Kew Garden Hills, NY (US); Kenneth Wong, Elmhurst, NY (US)

Correspondence Address: KENYON & KENYON, 1500 K STREET, N.W., SUITE 700, WASHINGTON, DC, 20005, US

(21) Appl. No.: 10/400,460

(22) Filed: Mar. 28, 2003

Related U.S. Application Data
(63) Continuation-in-part of application No. 10/141,311, filed on May 8, 2002.

(51) Int. Cl. G06F 17/60

(52) U.S. Cl. 705/2

(57) ABSTRACT

A medical information system for facilitating the treatment of a patient by a clinician is provided. The medical information system may include a processor. The medical information system may include an input device readable by the processor. The medical information system may include a demographic information interface configured to allow the input of patient demographic information for the patient from the input device. The medical information system may include a medical history interface configured to allow the input of medical history information for the patient from the input device. The medical information system may include an examination interface configured to allow the input of examination information for the patient from the input device The medical information system may include a diagnosis interface configured to allow the clinician to select a diagnosis using the input device.

### RELATED APPLICATION

This application is a continuation-in-part of U.S. application Ser. No. 10/141,311 filed May 8, 2002, which is hereby incorporated by reference in its entirety.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

A medical doctor's or other clinician's treatment of a patient may include many different tasks, some of which are performed by the doctor, others by persons assisting or working under the supervision of the doctor. These tasks include the collection and review of patient demographic and medical history information, the examination of the patient, the determination of one or more diagnoses, the ordering of tests, treatments, or prescribing of medication, and the completion of an examination record, including billing and/or insurance information. Computer or computer-aided systems have been developed to aid in some of these tasks.

In many clinics, patient charts and notes are maintained on paper files using standard paper charting techniques. For physicians with many patients, the paper work can often be overwhelming. Similar problems may be encountered by other clinicians, such as dentists or veterinarians. The extensive process of generating and finishing a clinical patient note without the use of computers is often time consuming and inefficient. At the same time, many clinicians are not highly computer literate or resist using computer tools that are not easy to use.

Electronic medical record systems (EMR) do exist that are usable by clinicians, but these systems are still time consuming and cumbersome to use. These systems may require manual generation and completion of findings reports. They may also require search for medication codes and/or diagnoses from books or separate databases. Conventional EMRs exhibit limitations in customizing the interface such as the layout of the interface, items in the layout, and/or scope of customization.

Automated diagnosis systems exist, but are generally not integrated with patient record keeping tools. Many of such systems are highly specialized, with their use limited to a single specialized treatment area.

Standard diagnosis classifications and code sets exist and are commonly employed by clinicians. An example diagnosis code set is the ICD-9 standard. ICD stands for “international classification of diseases”. Another code set is the SNOMED universal insurance code set. Other standards are also in use in different clinical specialties, e.g., the DSM-IV for psychiatry and mental health professionals.

### BRIEF DESCRIPTION OF THE DRAWINGS

Embodiments of the present invention are illustrated by way of example, and not limitation, in the accompanying figures in which like references denote similar elements, and in which:

FIG. 1 illustrates an example high-level design for an example medical information system, according to an example embodiment of the present invention.

FIG. 2 illustrates an alternative example high-level design for the example medical information system.

FIG. 3 illustrates an example high-level patient interface provided as part of an example medical information system in accordance with an embodiment of the present invention.

FIG. 4 illustrates an example settings interface which may be provided as part of an example medical information system in accordance with an embodiment of the present invention.

FIG. 5 illustrates an example customization interface provided as part of an example medical information system in accordance with an embodiment of the present invention.

FIG. 6 illustrates an example customization template interface provided as part of an example medical information system in accordance with an embodiment of the present invention.

FIG. 7 illustrates an example customization interface provided as part of an example medical information system in accordance with an embodiment of the present invention.

FIG. 8 illustrates an example template-sharing interface provided as part of an example medical information system in accordance with an embodiment of the present invention.

FIG. 9 illustrates an example customization template interface provided as part of an example medical information system in accordance with an embodiment of the present invention.

FIG. 10 illustrates an example interface that provides template sharing as part of an example medical information system in accordance with an embodiment of the present invention.

FIG. 11 illustrates an example customization template interface as part of an example medical information system in accordance with an embodiment of the present invention.

FIG. 12 illustrates an example of an input interface provided as part of an example medical information system in accordance with an embodiment of the present invention.

FIG. 13 illustrates an example of an input interface provided as part of an example medical information system in accordance with an embodiment of the present invention.

FIG. 14 illustrates an example of a high-level patient interface that may be provided as part of an example medical information system in accordance with an embodiment of the present invention.

FIG. 15 illustrates an example of a template selection interface that may be provided as part of an example medical information system in accordance with an embodiment of the present invention.

FIG. 16 illustrated an example procedure input interface that may be provided as part of an example medical information system in accordance with an embodiment of the present invention.

FIG. 17 illustrates an example procedure template interface that may provided as part of an example medical information in accordance with an embodiment of the present invention.

FIG. 18 illustrates an example procedure template interface that may be provided as part of an example medical information in accordance with an embodiment of the present invention.

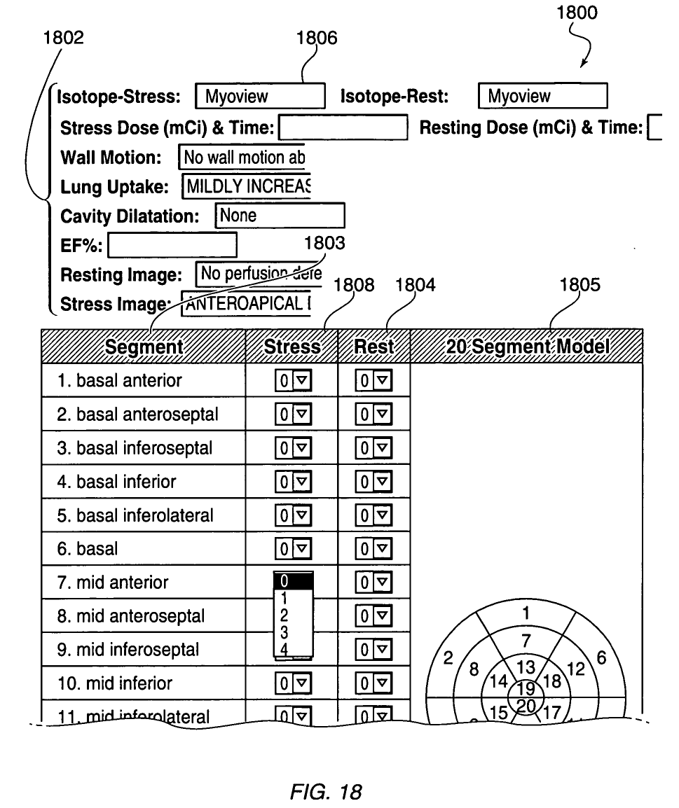

FIG. 19 illustrates an example graphics interface that may be provided as part of an example medical information system in accordance with an embodiment of the present invention.

FIG. 20 illustrates an example of a coding interface that may be provided as part of an example medical information system in accordance with an embodiment of the present invention.

FIG. 21 illustrates an example of a coding interface that may be provided as part of an example medical information system in accordance with an embodiment of the present invention.

FIG. 22 illustrates an example of a coding map interface that may be provided as part of an example medical information system in accordance with an embodiment of the present invention.

FIG. 23 illustrates an example off-line backup interface that may be provided as part of an example medical information system in accordance with an embodiment of the present invention.

FIG. 24 illustrates an example interface providing an auto-complete feature as part of an example medical information system in accordance with an embodiment of the present invention.

FIG. 25 is a flow chart illustrating a method in accordance with an embodiment of the present invention.

### DETAILED DESCRIPTION

An example medical information system (MDIS) may be provided, according to an example embodiment of the present invention. The example medical information system may incorporate an artificial intelligence or matching system using a standard diagnostic code set (e.g., the ICD-9 standard codes) and/or a standard procedural code set (e.g., the CPT standard codes). The example MDIS may include interfaces for inputting and/or reviewing patient demographic and medical information, interfaces for inputting and/or reviewing positive findings and physical exam results, an interface for selecting a diagnosis, and an interface for selecting medications or procedures.

n accordance with embodiments of the present invention, the example MDIS may include artificial intelligence or matching techniques to facilitate more rapid input of information by the clinician, and to suggest candidate diagnoses or medications based on the information collected by the system. The matching or artificial intelligence techniques may be based on standard diagnostic code set, e.g., the ICD-9 standard code set and/or a standard procedural code set (e.g., the CPT standard codes).

Embodiments of the present invention may provide interface templates that may be dynamically created and/or customized by users based on personal preference, efficiency, ease of use, etc. and/or any combination thereof. In embodiments of the present invention, created and/or customized interface templates may be uploaded and/or shared with other users of the MDIS such as other doctors, groups, and/or MDIS community.

Embodiments of the present invention may provide billing interfaces that may use the standard diagnostic code set, e.g., the ICD-9 standard code set (International Classification of Diseases, Revision 9) and/or standard procedural terminology, e.g., CPT (Current Procedural Terminology), to efficiently generate accurate bills for patient services provided. A mapping interface between the ICD-9 and/or CPT may be provided for billing efficiency, accuracy and/or billing flexibility.

Embodiments of the present invention may provide a server based MDIS that can be accessed and/or modified using an Intranet, Internet, other type of connections and/or any combination thereof. It is recognized that embodiments of the present invention may be provided as part of a local area network (LAN). The MDIS may provide an off-line backup and/or access system for downloading and/or accessing data off-line. The MDIS may provide other features such as a system based auto-complete function that may assist in efficient data entry by clinicians and/or other users. It is recognized that the plurality of interfaces may be provided to the user as web pages that may be accessible via a standard web browser.

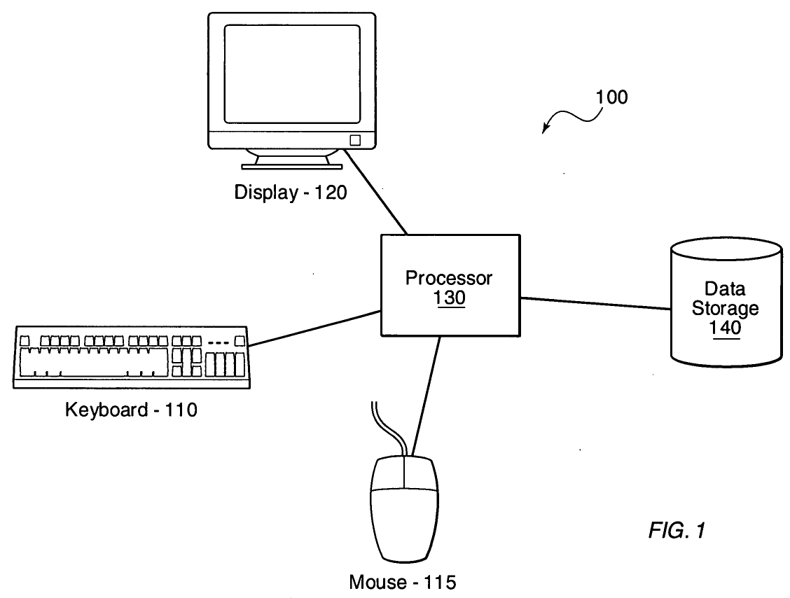

FIG. 1 illustrates a high-level design for an example MDIS in accordance with an embodiment of the present invention. The example MDIS may be provided in a standalone mode on a single computer system 100, for example, on a clinician's laptop computer, desktop computer, and/or other electronic device such as a personal digital assistant (PDA). The device that is used to access the system may be referred to as the client terminal.

The client terminals may include various input interfaces, e.g., a keyboard 110, a mouse 115 and/or any other input device. It will be appreciated that other types of interfaces may be provided, e.g., a voice interface, a pen-based interface, a touch screen interface and/or any other mechanisms or combination thereof, that enable a clinician to enter data in the system. The computer system may also include a display 120, which may be configured to allow for the display of information to the clinician.

In embodiments of the present invention, a clinician or user may manually enter medical test data from a medical device (e.g., a CAT scan, EKG, etc) into the MDIS via the client-input interface. It is recognized that the client terminal may also be coupled to the medical device to automatically download test data into the MDIS.

In embodiments of the present invention, the example MDIS may also include a processor 130 for controlling the operation of the MDIS. The example MDIS may also include a storage system 140 directly accessible by the processor, for saving standard information needed by the MDIS, such as pharmaceutical information, symptom and diagnosis information, etc., as well as information regarding specific patients. The storage system 140 may include memory, disks, CD-ROMs, or other information storage technologies. The storage system 140 may also be used to store patient information entered by the clinician, or by others, e.g., a receptionist, nurse, or assistant.

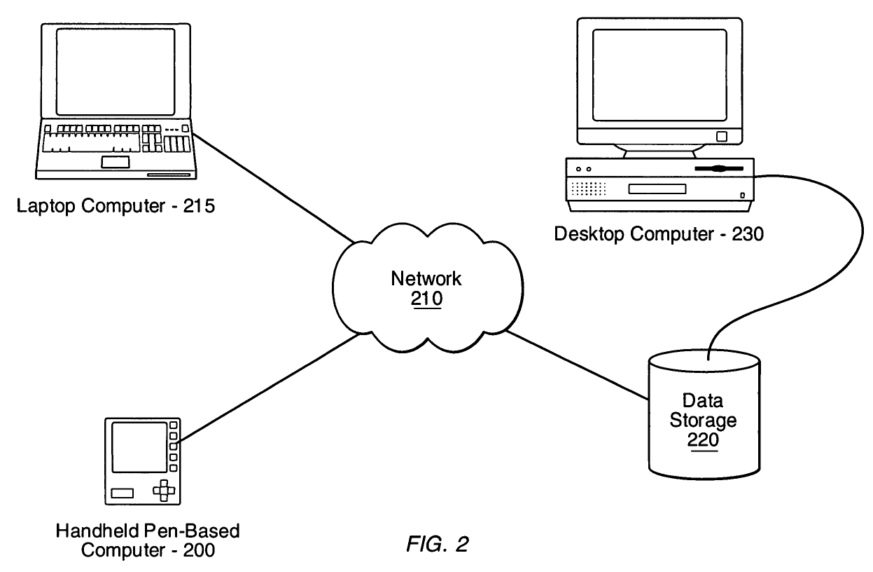

FIG. 2 illustrates an alternative example high-level design for the example MDIS. The alternative example high-level design may be provided as a distributed or networked computing system. A handheld computing device 200 may be used by the clinician to receive information from and/or input information to the MDIS. The processor which performs the processing required for the MDIS may be located on the hand-held computing device. It will be appreciated that the processor may also be located elsewhere in the system, with the handheld computing device merely providing input-output capabilities for the clinician. The handheld computing 200 device may be connected to a transit network 210. The network 210 may be wired or wireless, e.g., a wireless Internet connection. Multiple clinicians or users may have access to the system, e.g., a second clinician may have access through a laptop computer 215. It is recognized that additional devices such desktop computers, laptop computers, other handheld devices, etc. may provide access to the MDIS.

In embodiments of the present invention, transit network 210 may be a communications network that may include, for example, a public switched telephone network (PSTN), an Integrated Services Digital Network (ISDN), a cellular network, a digital mobile network, a Personal Communication Systems (PCS) network, an Internet, an intranet, a signaling system 7 (SS7) network, a local area network (LAN), a satellite network, an advance intelligent network (AIN), any suitable digital or analog network, a broadband network such as a cable network, any other suitable national and/or international communications network or any suitable combination thereof.

In embodiments of the present invention, the transit network 210 may include a plurality of switches, communication interfaces, and/or other components that are not shown for convenience. It is recognized that the communications that may be provided may include hard-line, wireless, RF, optical, or any other type of communications or any combination thereof. The various devices, systems, networks, etc. may be appropriately configured or equipped with hardware and/or software to operate in such environments.

In embodiments of the present invention, a storage system 220 may also be connected to the network 210. In embodiments of the present invention, the storage system 220 may be a web-server that may be accessible via the Internet, for example. The storage system 220 may contain standard information used for all patients, such as pharmaceutical information, as well as information on particular patients. The storage system 220 may include memory, disks, CD-ROMs, or other information storage technologies.

In embodiments of the present invention, the storage system 220 may be provided as a file server, web server, database server, or other type of system used to hold and manage the stored information. The information contained in storage system 220 may be accessible to the handheld computing device 200 via the network 210. Other users may access the data storage, e.g., to input patient medical history or update the standard information stored on the storage system 220, e.g., with a desktop computer 230 connected directly to the data store 220.

In embodiments of the present invention, a program providing the MDIS service (referred to herein as the MDIS program) may reside in the data storage system 220 and/or any other storage device or MDIS server coupled to the network 210. The MDIS service provider may access the MDIS program residing on the MDIS server via a computer such as a laptop, desktop, and/or a handheld device such as a PDA. The computer and/or other device may be coupled to the MDIS server either directly or indirectly such as via the network 210 or other connection.

In this example, desktop computer 230 may be used by the MDIS service provider to access the MDIS program. Moreover, in this example, data storage 220 may be the MDIS server in which the MDIS program resides. It is recognized that the data storage 220 may be located internal to and/or external to the desktop computer 230. It is further recognized that the MDIS program may reside in a storage memory located in the desktop computer 230, for example, and/or any other memory located locally to and/or remotely from the desktop computer 230. In embodiments of the present invention, the MDIS program may reside locally on the computer of the MDIS user such as computer 215, 200 and/or other device.

It is recognized that the MDIS program may provide the various MDIS interfaces, functions and/or features, to be discussed below in more detail, in accordance with embodiments of the present invention. The MDIS program may be provided or generated using proprietary software programs, open source code and/or a customized commercial of the shelf (COTS) software program and/or any other software and/or hardware combination. It is recognized that MDIS users can access the MDIS program using any web browser and/or other program running on their computer.

It is recognized that the MDIS program, in accordance with embodiments of the present invention, may be provided by one of ordinary skill in the art in a variety of different ways. For this reason and/or for efficiency and/or simplicity, sample code for the MDIS program is not provided herein.

In an embodiment of the present invention, the MDIS service may be provided as an application service provider (ASP) model. The MDIS service provider may manage and/or distribute MDIS related software-based services and/or solutions to customers across a wide area network from a central data center.

The MDIS ASP may provide the MDIS service to customers or subscribers based on a recurring and/or lump sum fee. An MDIS administrator may control access MDIS services provided to its subscribers. The MDIS administrator may control access to the MDIS program, MDIS data and/or MDIS servers and/or computers by its customers. Subscribers of the MDIS service may include, for example, clinics, hospitals, ambulance service, governments, etc.

In one example, a MDIS administrator and/or information system administrator may control the method and/or type of access to the MDIS service by its users. Various levels of permissions may be established for MDIS users. Users of the MDIS service may include clinicians, clerical staff, assistants, and others.

In embodiments of the present invention patient data and/or any other data for use with and/or by the MDIS program may reside in the same storage memory as the MDIS program and/or may reside in a different and/or remote storage memory. It is recognized that the data being transmitted and/or received between the MDIS service provider and its clients may be encrypted using any method. Data stored in servers may further be encrypted using any method.

It will be appreciated that other possible arrangements of the elements of the MDIS may also be employed, e.g., using other conventional client-server or web-based architectures.

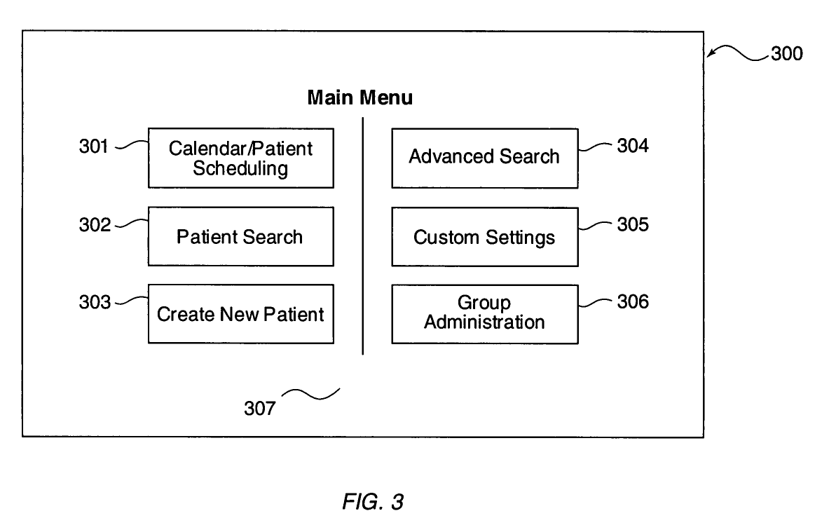

FIG. 3 illustrates an example high-level MDIS interface provided as part of an example MDIS in accordance with an embodiment of the present invention. The plurality of interfaces provided, in embodiments of the present invention, may be provided as a custom designed interface, as a web page implemented in HTML and/or with other web-authoring tools or standards, as a window-based application in a client-server system, and/or with other conventional approaches to provided interactive user interfaces. It is recognized that other interfaces or layers of interfaces may be provided either separately or as part of the high-level patient interface, e.g., a password protected access screen may be included, user customization of the interfaces may be provided, etc.

The interface menu 300 may include a MDIS menu configured to provide access to MDIS functions needed to provide services, in accordance with embodiments of the present invention. MDIS functions may be selected using a plurality of selection buttons or hyperlinks 301 to 306. These buttons may include calendar/patient scheduling 301, patient search 302, create new patient 303, advance search 304, custom settings 305 and/or group administration 306. The MDIS main menu may also include a logout button 3070 to log out of the MDIS system.

It is recognized that the configuration of main menu 300 shown in FIG. 3 and/or the configuration of any other menu described herein is given by example only and a MDIS customer, user and/or administrator can configure the menus in any desirable way. For example, selection buttons shown in MDIS main menu 300 and/or shown in any other menu described herein are given by way of example only and that buttons may be added and/or deleted as desirable. The various menus as described herein may be customized by the MDIS customer, user and/or administrator based on personal preference, efficiency, ease of use, etc. Embodiments of the present invention provide increased flexibility in customizing the layout, content, and/or customization scope (e.g., group versus individual customization) of the plurality of MDIS interfaces described herein.

In embodiments of the present invention, selection of calendar/patient scheduling button 301 may provide a calendar and/or scheduling interface (not shown) that may be used to quickly schedule patient visits. It is recognized that a plurality of different calendar or scheduling features may be employed in accordance with embodiments of the present invention. Selection of patient search button 302 may provide a search menu interface (not shown) to search for patients by, for example, name, age, symptoms, diagnoses, disease, geographic region, ethnicity, and/or any other criteria. Selection of create new patient button 303 may provide a new patient interface (not shown) including a plurality of input fields to create a new entry for a new patient in the MDIS system. Selection of the advanced search button 304 may provide an advanced searching interface (not shown) with additional fields to search for patients, service providers, medications, etc.

In embodiments of the present invention, selection of the custom settings interface 305 may provide a customization interface that may enable the user and/or administrator to modify and/or customize the various interfaces of the MDIS, to be describe below in more detail.

The group administration button 306 may permit the user and/or MDIS administrator to create the multi-level access privileges and/or permissions for individual users and/or a group of users. In embodiments of the present invention, it is recognized that access to the plurality of MDIS menus can be limited based on multi-level access privileges. For example, a MDIS administrator may create access and/or security levels that permit different levels of access to different types of users. For example, a level 1 access may be designated to clerical staff and may permit access to some MDIS menus and/or some buttons. Thus, in this example, level 1 access (e.g., low level access) may permit access to the main menu 300, but may only show buttons 301 to 303 and 307 for selection. Access to buttons may 304 to 306 may be limited to users with higher level access such as level 3 or higher, for example. Higher level access may be limited to, for example, certain users such as office administrators, MDIS administrators, information system administrators or the like.

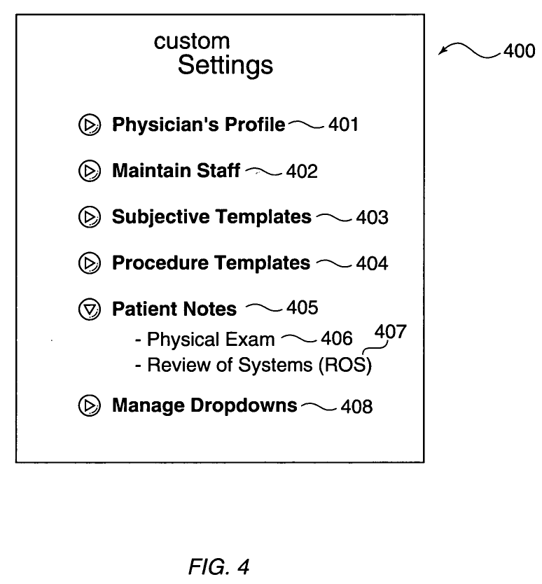

FIG. 4 illustrates an example customs settings interface 400 that may permit the user to choose which template, notes, drop downs, etc. to customize, in accordance with embodiments of the present invention. For example, custom settings interface 400 may include buttons such as physician's profile 401, maintain staff 402, subjective templates 403, procedure templates 404, patient notes 405 and/or manage dropdowns 408. It is recognized that these entries are given by way of example only and that more entries may be included in interface 400. Moreover, the entries may include template subcategories that may be expanded to show additional templates that may be available for selection and/or modification. For example, selection of button 405 may reveal physical exam template 406, review of systems (ROS) template 407, etc. Selection of buttons 401 to 408 may provide a corresponding template interface to customize the corresponding interface. Thus, a user may customize the layout, content, features, look, etc. of interface 400 as desired (as described below in more detail).

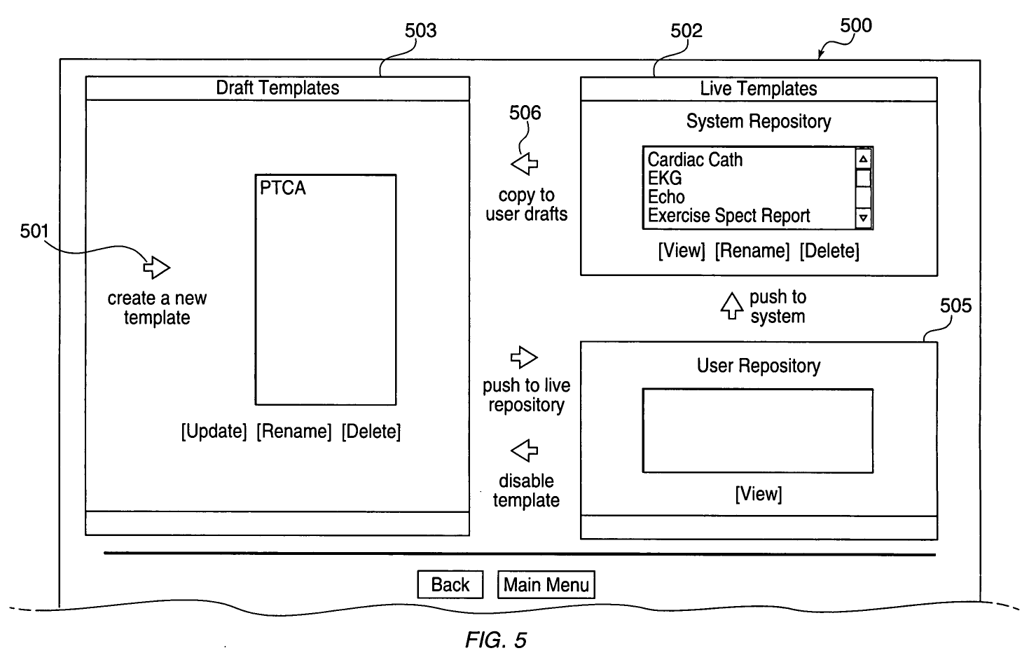

For example, selection of the procedural template button 404, as shown in FIG. 4, may retrieve interface 500, as shown in FIG. 5, for customizing procedure templates, to be described below in more detail. The interface 500 may include a draft level 503, user level 505 and/or a system level 502.

In embodiments of the present invention, the draft template section 503 may be used to create a new template and/or edit an existing template from existing templates 502 from system repository selecting copy to user drafts 506. It is recognized that a user can also edit, rename, delete and/or update a previously created, existing and/or edited templates.

In embodiments of the present invention, to create a new template, the user may select the create a new template button 501. The user may create a name such as “PCTA” for a new procedure template and/or the user may choose or activate an already existing template from the live templates section 502. If the user wants to use an existing template, the user may choose the template from the live templates section 502 and press copy to user drafts button 506 to edit, modify and rename the existing template from the live templates section 502. Once a new template and/or existing template has been chosen, the user may then presses the “update” button to customize the template as desired.

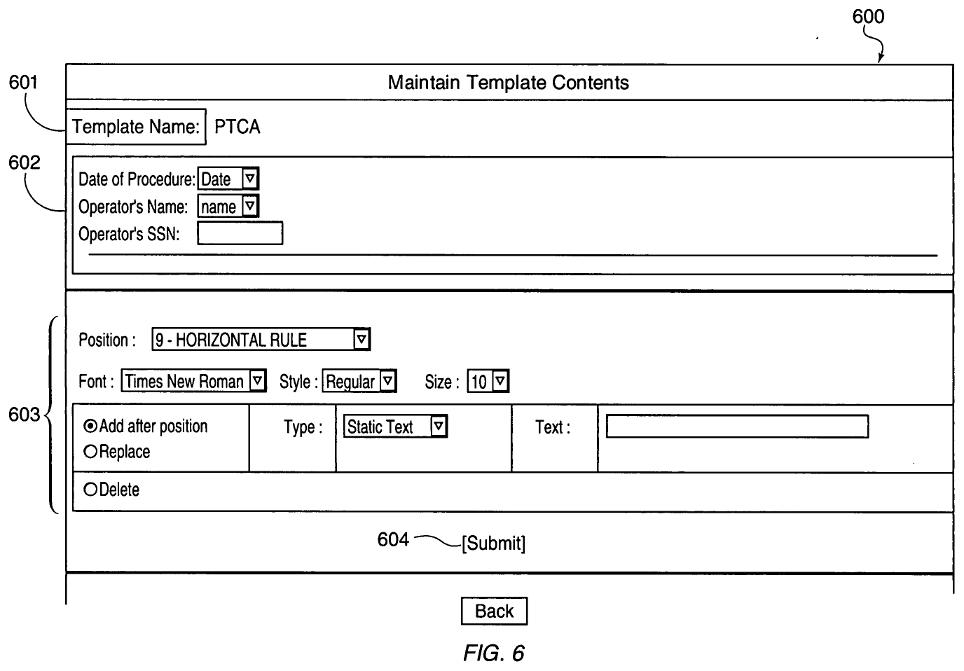

FIG. 6 illustrates an exemplary interface template 600 that may be created and/or edited in accordance with embodiments of the present invention. In this example, the name of the interface template, e.g., “PTCA”, may be included in section 601, for example. Section 602 of interface 600 may include some sample content entries that may be shown in the interface. It is recognized that the content entries shown in section 602 and/or interface 600 or other interfaces described herein, are given by way of example only and that additional entries and/or section may be included in interface template 600.

In embodiments of the present invention, section 603 may include controls that may permit the user to customize her interface based on ease of use, efficiency and/or personal preferences. For example, the user may select the text position to be customized and may select the font type, font style, font size, etc. for the corresponding text to be displayed and/or entered in the interface created based on, for example, interface 600. Additionally, the user may control how the input text can be entered. For example, the user may choose to enter text as static text or select text from a drop down menu or list, for example. Also, the user can control the look of the interface by, for example, inserting lines, creating line breaks, and controlling the text fields. In accordance with embodiments of the present invention, the user may control the various entries that may be included in the interface and/or may also control how the text may be entered in each of the entries, for example, via drop down list, static text, etc. The user may select the submit button 604 to submit the customized template as a draft template in section 503.

Embodiments of the present invention provide a customization interface that may permit a user to customize the layout of the various interfaces, the content of the variety of fields, etc. with relative ease. For example, the users may check or select boxes to activate or deactivate a group of items to be displayed in the data entry interface or form. The users may use up and/or down arrows to move the group of items in a specific data entry order, select links to another menu to add and/or remove items to the group of items, and customize lists such as drop down lists individually or customize the same list using another interface for a group of users.

In embodiments of the invention, the user may eliminate fields and/or add fields based on the type of medical procedure, type of treatment, medical specialty, and/or any other criteria. Users may tailor the layout of fields presented to them for data entry.

In accordance with embodiments of the present invention, MDIS service provider may permit the user to control and/or customization of the various MDIS interfaces as desirable. The MDIS service provider may present the various entries, options, etc. in the context of the template being modified and/or customized. For example, if a procedures template is being modified, the MDIS service provider may offer entries related to ordering lab tests and/or procedures, e.g., radiology, pathology, or other specialty procedures. The user may customize the look of the procedures template interface as well as the text corresponding to the corresponding entries.

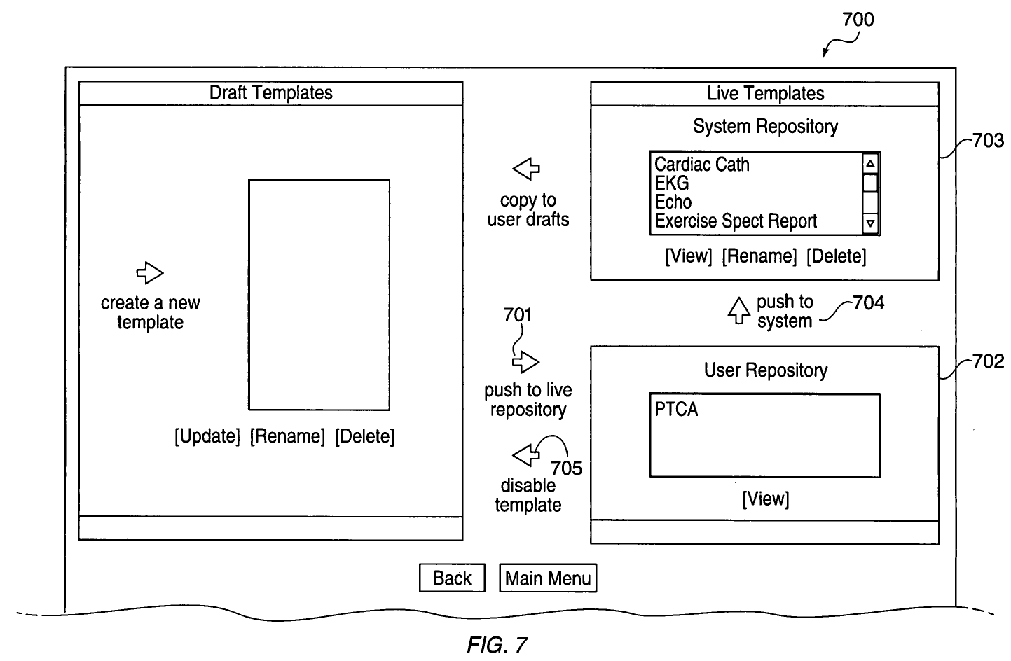

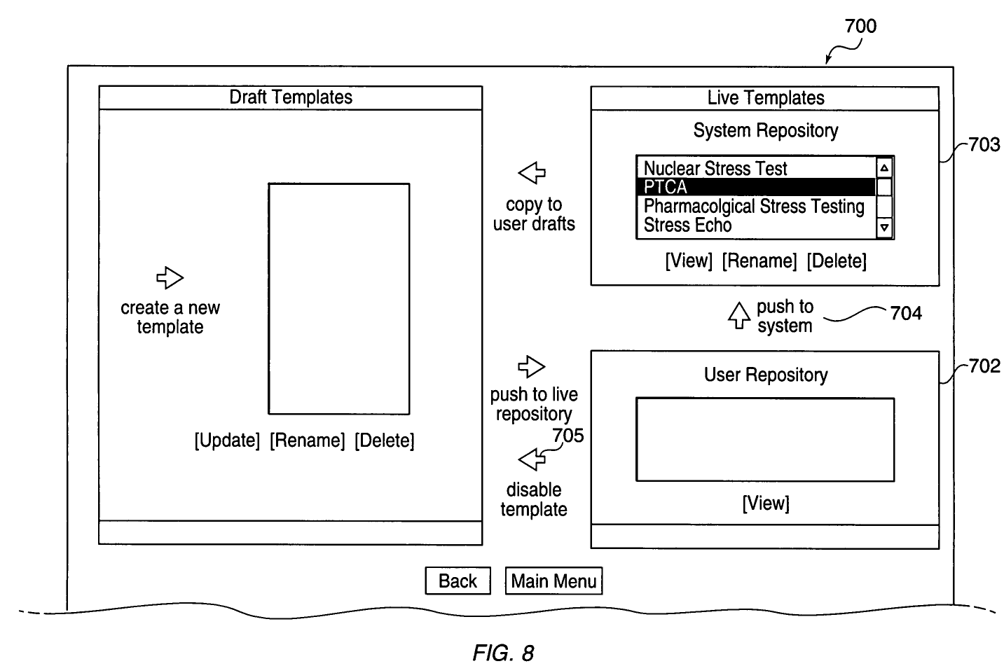

In embodiments of the present invention, once the user has created a new template and/or modified an existing template, the user may select button 701 to push the template “PTCA” to the live user repository 702, as shown in exemplary interface 700 in FIG. 7. If the user want to share the created and/or modified template with other users of the MDIS service, the user may select the push to system button 704 to move the “PTCA” template from the user repository 702 to the system repository 703, as shown in FIG. 8. It is recognized that templates stored in the system repository can be shared, e.g., by other practitioners in the same organization or shared based on individual basis and/or based on a group basis, for example. If the user wishes to remove, disable and/or modify a template from the user repository 702, the user may select the disable template button 705. It is recognized that an authorized user may remove and/or modify a template in the system repository 703.

In embodiments of the present invention, a template uploaded to the system repository 703 may be stored in the MDIS server or other storage memory and may be available to other users of the MDIS service. It is recognized that the MDIS administrator may control which templates if any should be accessible to other users of the MDIS service. For example, the MDIS system administrator may review each of the uploaded templates and may release the template so that other users of the MDIS can down load the template for use and/or further modification.

Referring again to FIG. 4, the user may select the subjective templates button 403 to customize an existing template from the system repository 500 or to generate a new template, in accordance with embodiments of the present invention.

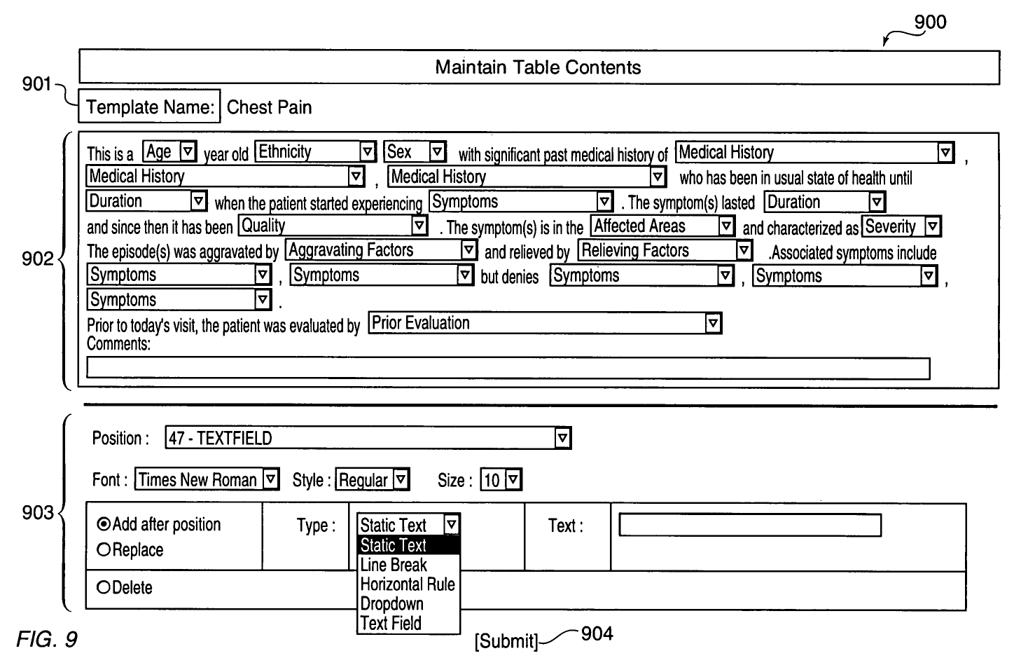

FIG. 9 illustrates an exemplary interface template 900 that may be customized, edited and/or created by the user. Interface 900 may be a template that may be used to enter subjective information about a patient during examination, for example. In this example, the name of the interface template, e.g., “Chest Pain”, for a template for entering chest-pain related information, may be included in section 901, for example. Section 902 of interface 900 may include some sample content entries that may be included in the interface. It is recognized that the content entries shown in section 902 and/or interface 900 are given by way of example only and that additional entries and/or section may be included in interface template 900.

In embodiments of the present invention, section 903 may include controls that may permit the user to customize her interface based on ease of use, efficiency and/or personal preferences, as described herein. For example, the user may select the text position to be customized and may select the font type, font style, font size, etc. for the corresponding text to be displayed and/or entered in the interface created based on, for example, interface 900.

The user may control how the input text can be entered. For example, the user may choose to enter text as static text or select text from a drop down menu or list, for example. Also, the user can control the look of the interface by, for example, inserting lines, creating line breaks, and controlling the text fields. In accordance with embodiments of the present invention, the user may control the various entries that may be included in the interface and/or may also control how the text may be entered in each of the entries, for example, via drop down list, static text, etc.

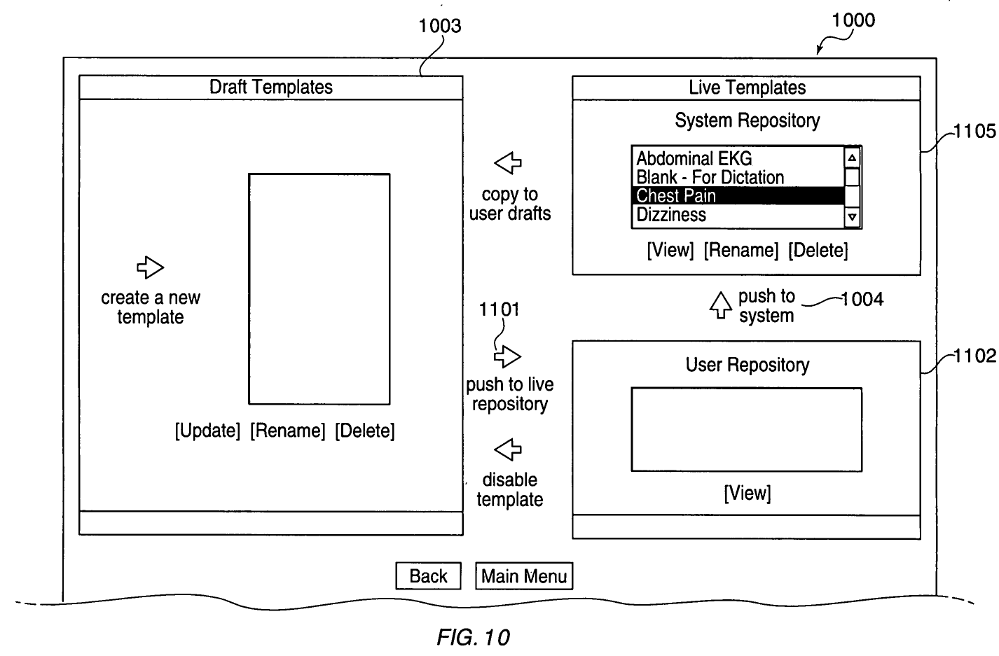

Once the template 900 has been completed, the user may select the submit button 904 to submit the customized template as a draft template in section 1003 of interface 1000, as shown in FIG. 10. The user may activate the new and/or modified template to the user level by selecting the move to the user repository 1002 by selecting button 1001, for example. The user may share the new or modified template with other users by moving the template to the system repository 1005 by selecting push to system button 1004.

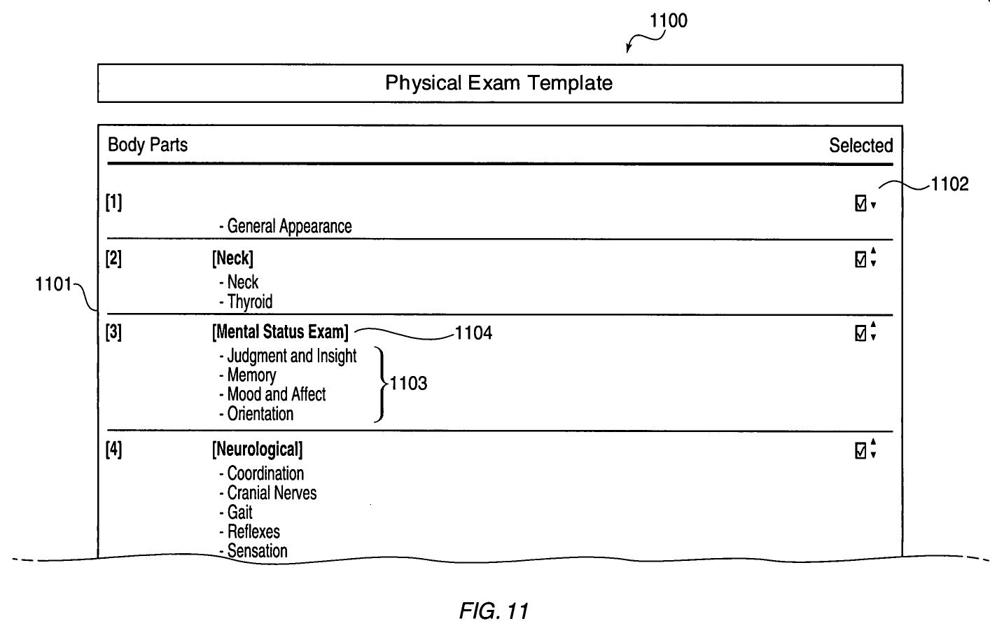

FIG. 11 illustrates an example physical template interface 1100 that may be retrieved by selecting physical exam button 406 that may be included in interface 400, in accordance with embodiments of the present invention. Physical exam template 1100 may include a section of examination body parts, organs or other type of examination in section 1101 that a doctor may want to examine. It is recognized that only a few body parts for examination are shown and that additional body parts may be included in template 1100. The user may select the desired part and/or organ by marking selection 1102. In embodiments of the present invention, the entry 1104 and/or subentries listed in section 1103 may be customizable to the preferences of the user or clinician. For example, a cardiologist may have an extensive section for the heart and/or respiratory system, while their section for other organs or body parts may be less extensive.

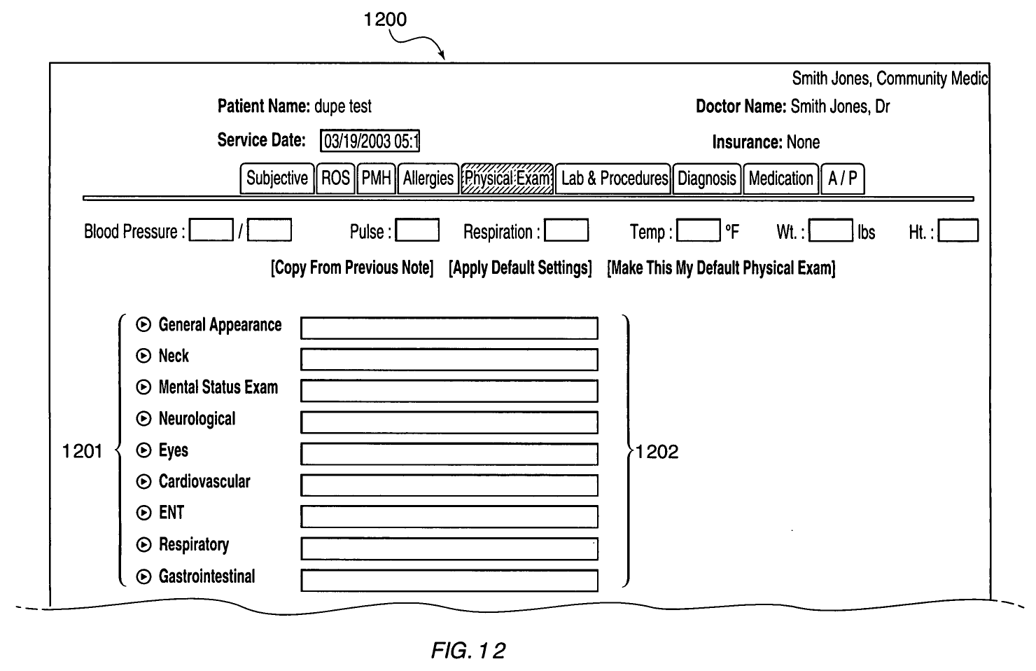

FIG. 12 illustrates an example physical exam interface 1200 provided as part of an example MDIS, according to an example embodiment of the present invention. The physical exam interface 1200 may be created based on the entries and/or customizations shown in FIG. 11, for example. Interface 1200 may permit a clinician to efficiently enter results of examination with respect to entries 1201, for example, in corresponding text boxes 1202. The text boxes may include drop down menus and/or may include static text as may have been selected by the user based on personal preference, as described above.

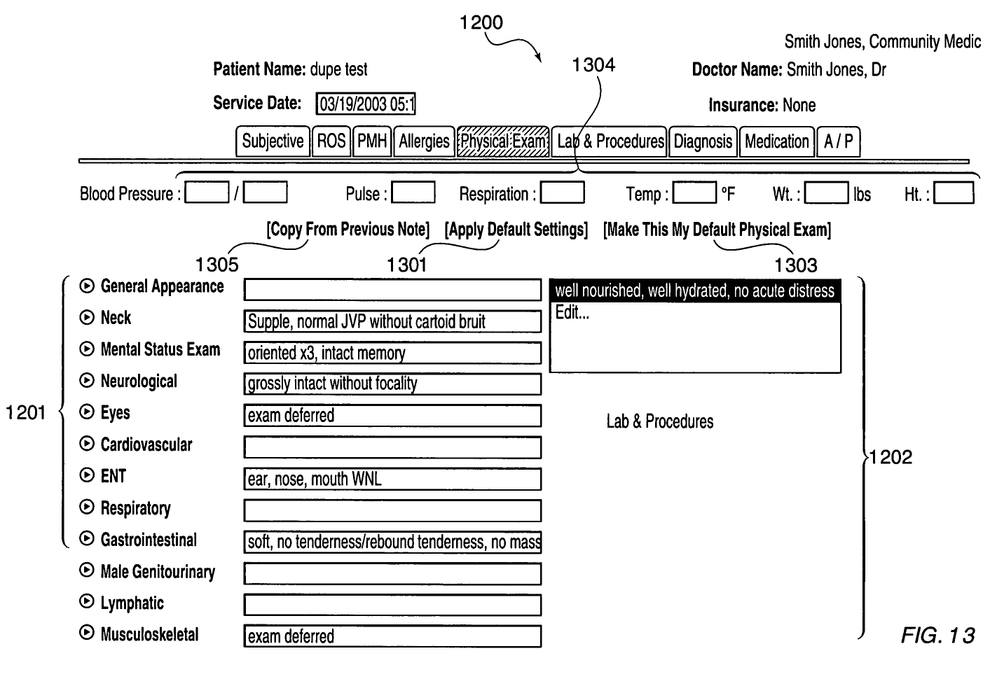

As shown in FIG. 13, if the user selects the apply default settings button 1301, the MDIS system may automatically populate text boxes 1202 with pre-determined default entries of interface 1200, in accordance with embodiments of the present invention. These predetermined entries may be previously selected or indicated by the user, designated by the MDIS service and/or generated based on the age, pulse, blood pressure, temperature, or other vital statistics of the patient as shown in section 1304. The user may edit the default entries in text boxes 1202 based on the results of the examination.

In embodiments of the present invention, a user may set generic defaults for all patients or they may have defaults customized for each patient, group of patient, based on the user herself and/or a group of users. The user may also copy a patient's previous notes or entries from the patient's previous visit and modify or update these notes as needed.

In embodiments of the present invention, once the user has completed the examination procedure and has updated the plurality of text boxes 1202, the user may choose to save the examination results by selecting make this my default physical exam button 1303. By selecting the make this my default physical exam button 1303, the current entries and/or setting for the patient being examined may be saved and/or uploaded by the MDIS service. In embodiments of the present invention, the data may be stored in MDIS servers or locally at the client terminal, for example. If the patient returns for another visit, the user may have the option of applying default values by selecting apply default settings button 1301 or the user may download data from the patients earlier visit by selecting copy from previous notes button 1305. If button 1305 is selected, the text boxes 1202 may be populated with information downloaded from the MDIS server, for example. The user may conduct the new examination and edit the text boxes 1202 as needed. The user may again save this information associated with the patient's current visit to the MDIS servers.

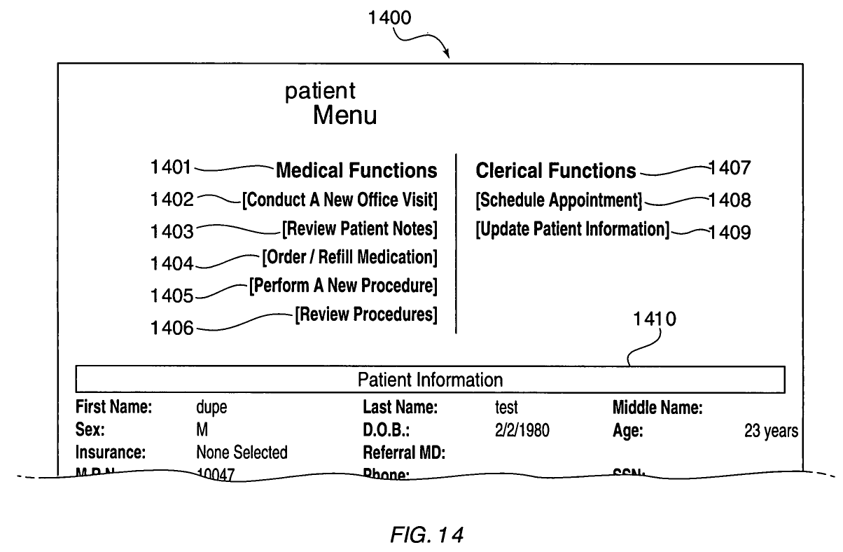

FIG. 14 illustrates an example high-level patient interface 1400 provided as part of an example medical information system, according to an example embodiment of the present invention. The high level interface may include a patient menu configured to provide access to both medical and clerical functions needed to provide patient services. Medical functions may be selected using a plurality of buttons or hyperlinks 1401. These buttons may include conducting an office visit or examination 1402, reviewing patient notes or history 1403, ordering or refilling a prescription 1404, performing a procedure or lab test 1405, or reviewing procedure or lab test results 1406.

In embodiments of the present invention, clerical functions may also be selected using a plurality of buttons or hyperlinks 1407. These buttons may include appointment scheduling 1408 and updating patient information 1409. A patient record 1410 may also be displayed.

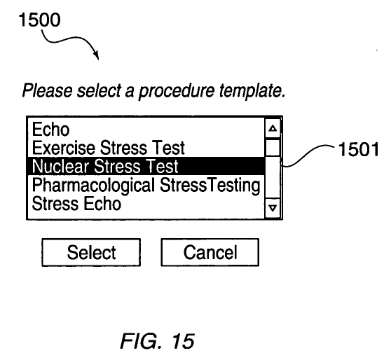

In embodiments of the present invention, if the user selects, for example, perform a new procedure button 1405, interface 1500 may be presented to the user, as shown in FIG. 15. The user may select a user template from the plurality of templates 1501 presented to the user. It is recognized that these templates may be standardized templates and/or may be customized templates produced in accordance with embodiments of the present invention. The user may scroll down to find the template associated the type of procedure to be performed by the user. For example, as illustrated in the figure, the user may select a template associated with a nuclear stress test from the selection of templates 1501 presented to the user.

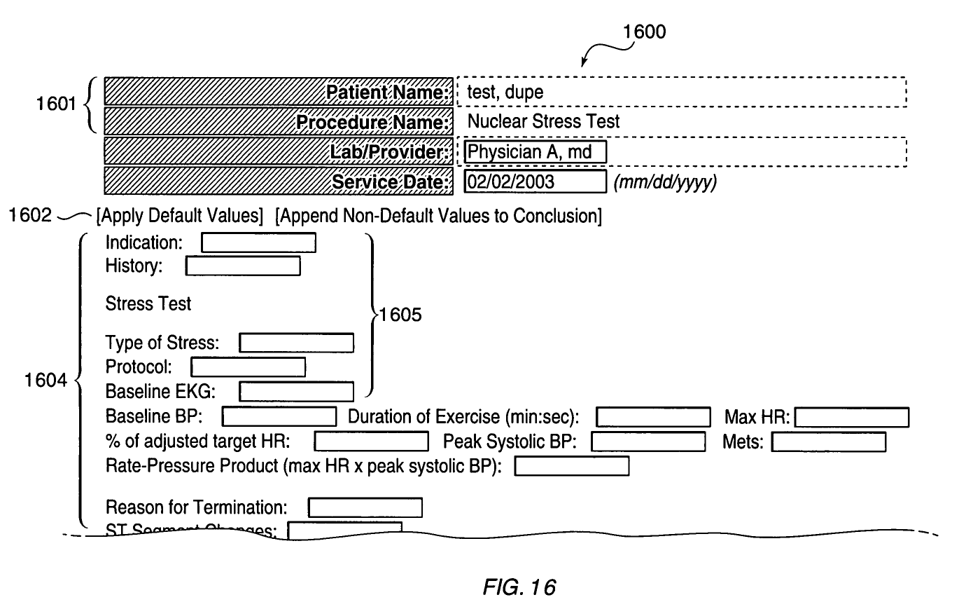

Once the selection is made, a template associated with the selection may be presented to the user, in accordance with embodiments of the present invention. Since the user selected stress test template via interface 1500, an exemplary nuclear stress test procedure template 1600 may be presented to the user, as shown in FIG. 16. The interface 1600 may include a section for patient information as well as the procedure name in section 1601, for example. The interface 1600 may include an apply default button 1602 which, upon selection, may download default values in text boxes 1605, for example, associated with the entries 1604, for example. The user may edit default values and/or enter new values based on the procedure conducted on the patient.

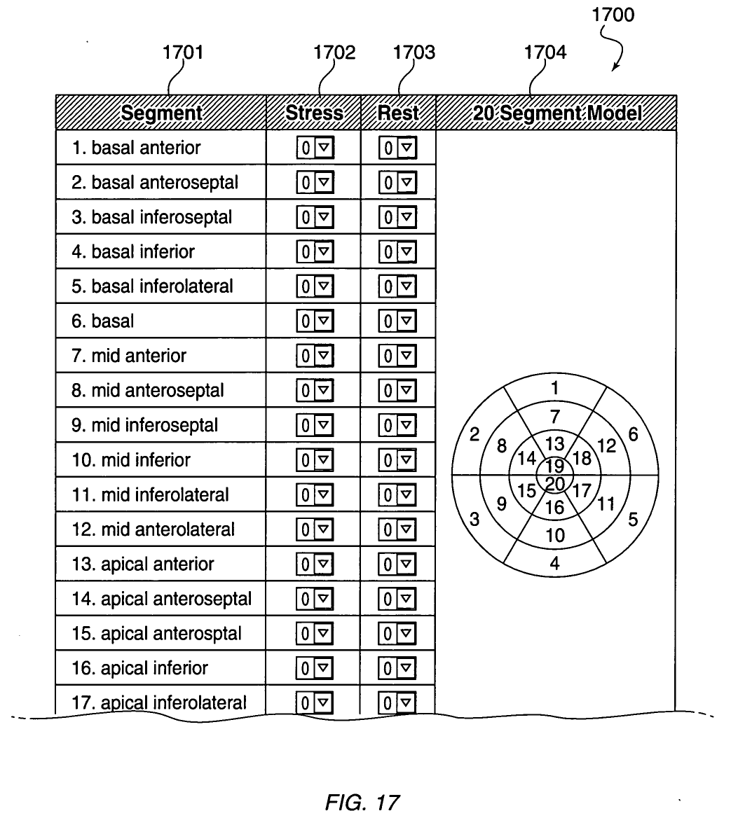

In embodiments of the present invention, the MDIS service may provide a nuclear procedure template interface 1700, as shown in FIG. 17. It is recognized that the interface 1700 may be provided with the nuclear stress test procedure 1600. The interface 1700 may include a heart segment list 1701, corresponding stress data 1702 and rest data 1703, and a segment model 1704, for example.

As the stress test is conducted, data in the various fields included in interface 1800 may be populated, as shown in FIG. 1800. Entries may be provided based on default values, drop down menus and/or static text. For example, data associated with test entries 1802, for example, may be input to the various text boxes such as text box 1806, for example. As the test is conducted, stress data 1808 and rest data 1804 associated with entries of the segment list 1803 may be generated. Moreover, in embodiments of the present invention, the segment model 1805 may be generated, as the associated data is determined. It is recognized the data may be entered manually and/or may be provided to the computer such as laptop computer 215 via an external interface (not shown).

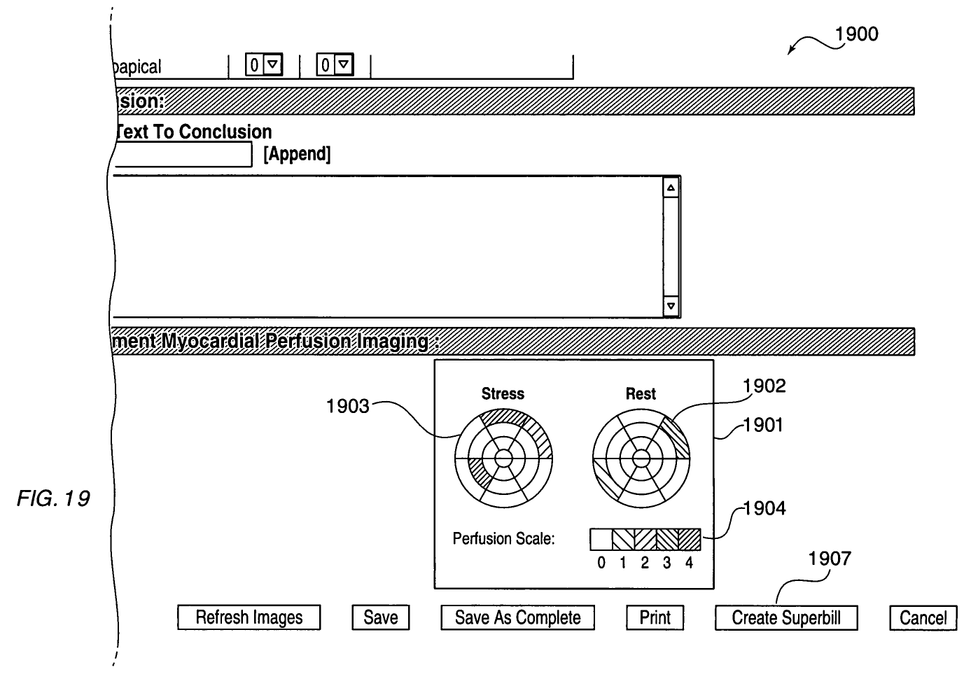

FIG. 19 illustrates an example imaging interface 1900 provided as part of an example MDIS, according to an example embodiment of the present invention. The imaging interface, in this example, may include a myocardial perfusion image 1901 including a stress graph 1903 and/or a rest graph 1902, based on the conducted stress test described above. In embodiments of the present invention, a perfusion scale 1904 may provide a color coded or gray scale legend to the perfusion graphs 1903 and 1902. MDIS interface 1900 may include a create super-bill button 1907 that may assist the user in generating an efficient and accurate bill for the conducted procedure, examination, and/or other provided service.

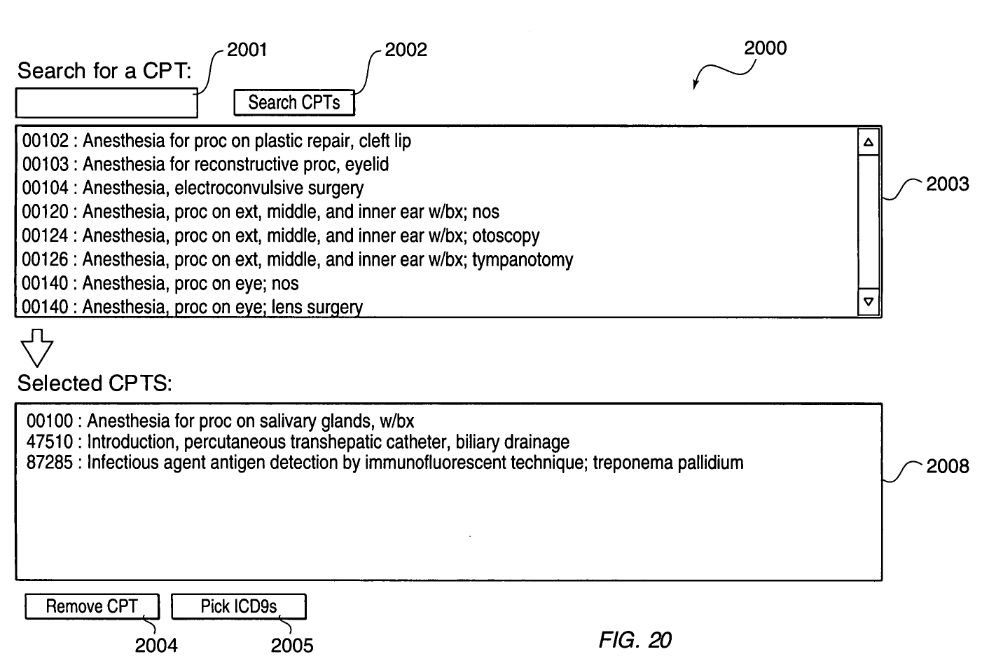

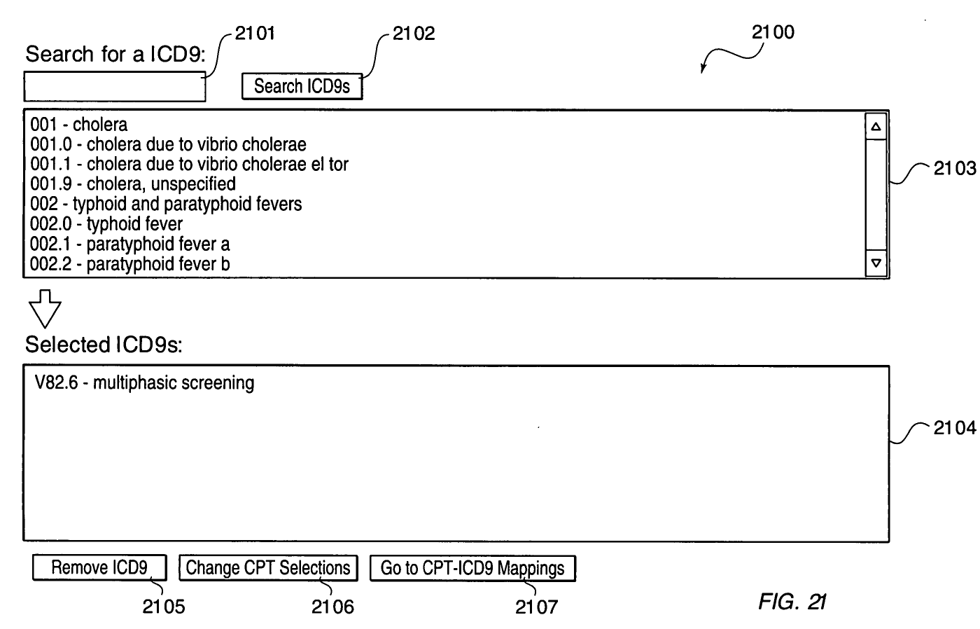

In this example, selection of the super-bill button 1907, in interface 1900, may present the user with an exemplary billing interface 2000 as shown in FIG. 20 and interface 2100 as shown in FIG. 21, for example. Similar selection of a super-bill button may be provided in other procedure interfaces.

FIG. 20 illustrates an example CPT billing interface 2000 provided as part of an example MDIS, according to an example embodiment of the present invention. Interface 2000 may provide one or more CPT (Current Procedural Terminology) codes associated with a particular examination, procedure and/or other services. As is known, CPT codes provide a uniform language that may describe medical, surgical, and/or diagnostic services. CPT codes are used to describe medical, surgical, radiology, laboratory, anesthesiology, and evaluation/management services provided by physicians, hospitals and/or other health care providers.

In an embodiment of the present invention, CPT codes may be provided in section 2003 based on the procedure, examination, etc. that was conducted on the patient. The user may also enter a key word in text box 2001 and press search CPT button 2002 to generate a list of corresponding CPT codes. The user may select the desirable CPT codes for a particular examination, procedure, patient, etc. that may be displayed as selected CPTs in section 2008. The user may remove CPTs from section 2003 by selecting the CPT for removal and selecting remove CPT button 2004.

In embodiments of the present invention, the user may select the pick ICD9 button 2005 that may be included in interface 2000. In response, the MDIS may present an example ICD9 billing interface 2100, as shown in FIG. 21, according to an example embodiment of the present invention.

As is known, CPT codes are linked with ICD9 codes. ICD9 (International Classification of Diseases, 9^{th} revision) coding system is used to code signs, symptoms, injuries, diseases, and conditions. The relationship between ICD9 codes (e.g., diagnoses codes) and CPT codes (e.g., procedural codes is that the diagnosis should support the medical necessity of the procedure. Thus, ICD9 codes represent symptoms of the patient that a paying party may require as a reasonable justification for the procedure used by the clinician. Since certain procedures may be associated with certain symptoms, MDIS may suggest related ICD9 codes in section 2103 based on the CPT selected by the user. The user may also enter a key word in text box 2101 and press search ICD9 button 2102 to generate a list of corresponding ICD9 codes. The results of the search may be displayed in section 2103, as shown in FIG. 21.

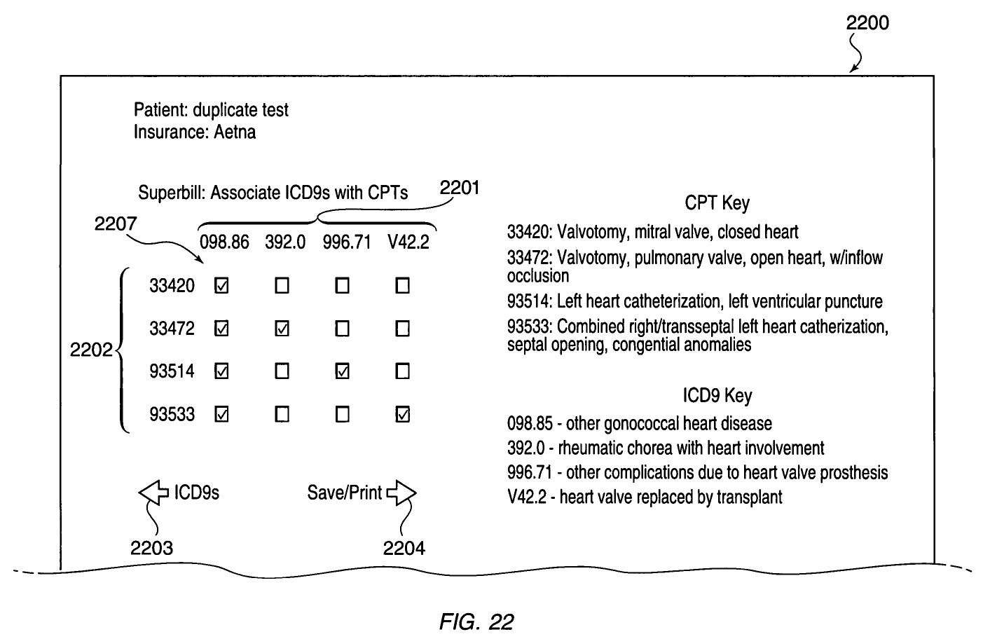

In embodiments of the present invention, the user may select the desirable ICD9 codes from section 2103 that may be displayed as selected ICD9s in section 2104. The user may remove ICD9s from section 2104 by selecting the ICD9 for removal and selecting remove ICD9 button 2105. The user may change the CPT9 selection by selecting change CPT9 selections button 2106. Once the user is satisfied by the ICD and/or CPT9 selection, the user may select the CPT-ICD9 mapping button 2107. The CPT-ICD9 mapping button may provide a mapping between the two types of codes that can be further checked for accuracy and/or modified for accurate and/or flexible billing, as shown in FIG. 22.

FIG. 22 illustrates an example billing interface 2200 provided as part of an example MDIS, according to an example embodiment of the present invention. In embodiments of the present invention. Interface 2200 shows a matrix 2207 that maps the CPTs 2202 with the ICD9s 2201. These CPTs and ICDs may have been selected earlier using interface 2000 and 2100, shown in FIGS. 20 and 21, respectively. The MDIS application may generate the matrix 2207 that may show all possible CPT and ICD9 codes for the user to select. The user may select or de-select each ICD9 code and/or the CPT code to accurately record the procedure performed and/or to provide accurate billing. For example, the physician may have opened a heart (e.g., CPT***x), punctured a valve (e.g., CPT***y), and closed the heart (e.g., CPT***z) because of a heart disease (e.g., ICD9***1), but not because of other complications (e.g., ICD9***2). However, the physician may have done another procedure (e.g., CPT ***v) because of other complications (e.g., ICD9***2). If the user wishes to select or deselect ICD9s and/or CPTs, the user may select button 2203 to return to interface 2100 and/or 2000. Once the proper information has been entered, the user may select save/print button 2204 to generate a super bill for the services provided.

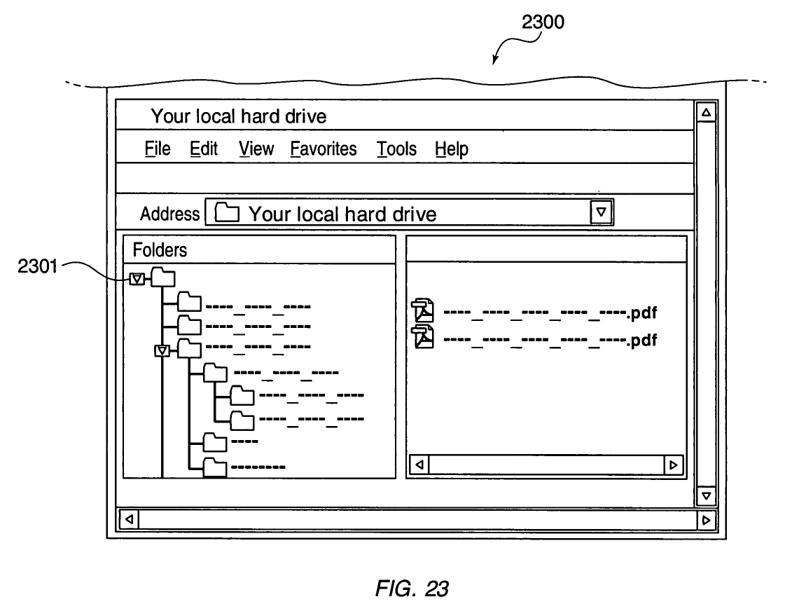

FIG. 23 illustrates an example off-line back-up system interface 2300 provided as part of an example MDIS, according to an example embodiment of the present invention. In embodiments of the present invention, users of the MDIS service may be able to download their patient, billing and other MDIS data from the MDIS server to another storage memory. The storage memory may be a local hard drive, floppy, zip disk, or any other media and/or may be another storage memory.

In embodiments of the present invention, the data may be down loaded as a portable document format (.pdf) file and/or any other type of data and/or graphics file format, or combination thereof. Once the data is down loaded, users can access such data even if the MDIS service is not available. Accordingly, this download feature may provide an extra level of security for the users in case of an emergency or other problem. The MDIS off-line back-up service may write files in to folders or directories in a hierarchical and organized format. Users may provide instructions to help create the various directories or folders as desired by users. Users may create folders for different patients, doctors, group of doctors and/or hospitals, for example, to store the offline data as shown in section 2301.

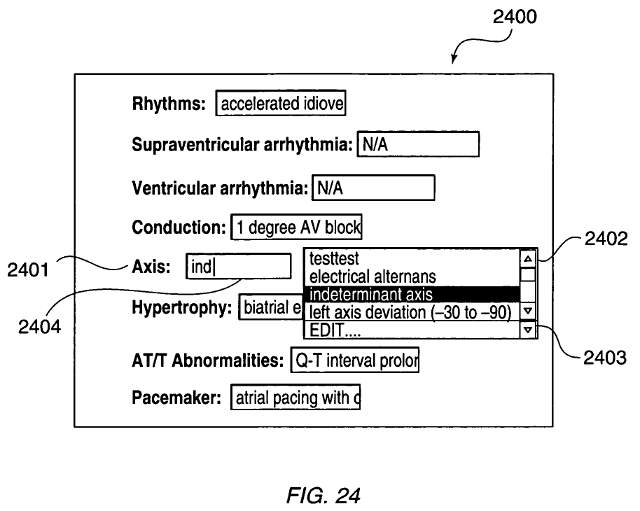

In embodiments of the present invention, the MDIS may provide a system or browser based text auto-complete feature that may increase efficiency and/or accuracy when entering text into the various interfaces of the MDIS service. FIG. 24 shows interface 2400 that illustrates the system based text auto complete function, in accordance with embodiments of the present invention. The MDIS may proved a context specific auto-complete function that may auto complete text entries based on the letters being entered by the user and/or the field that is being entered. For example, a user may start typing in the empty text field 2404 associated with entry 2401.

In embodiments of the present invention, the MDIS may generate a drop down menu 2402 that contains expected entries based on the text field 2404 associated with entry 2401, for example. The user may predetermine a list of entries that may be included in the drop down menu 2402 based on expected entries related to entry 2401, for example. This pre-determined list may be used to provide the auto-complete function, in accordance with embodiments of the present invention. The list may be predetermined by the user and default values may be edited, deleted, or other wise modified by the user as desired. For example, menu 2402 may include an entry, e.g., “EDIT . . . ” 2403 that may permit the user to directly add, edit, modify, delete, etc. any value in the dropdown menu 2402. The added and/or edited value may be used to auto-complete entries being entered by the user. The list of entries to be auto-completed may be stored on the MDIS server and/or system server and may be available to the user from any computer.

In embodiments of the present invention, once a match is found in the list 2402, the user can quickly make a selection of the desired text entry, in accordance with embodiments of the present invention. It is recognized that the text may be auto-completed without the drop down menu being displayed. In some cases, the MDIS auto-complete feature may disable the local auto-complete feature that may be available on the user's computer and/or provided locally at the user's terminal. Accordingly, the local auto-complete feature may be prevented from interfering from the system based auto-complete feature provided in accordance with embodiments of the present invention.

Accordingly, the auto-complete feature in accordance with embodiments of the present invention is different from conventional auto-complete features that merely remember previously typed entries and present accumulations of all typed entries in that field. In conventional auto-complete features, if the user changes computers, the entries previously typed will not be auto-completed. However, the present invention provides a system based auto-complete feature that will be available to the user from any computer. The user will be able to quickly enter the desired information using the previously selected or created default values in the context of the entry being typed. Accordingly, once a match is found the entry may be completed.

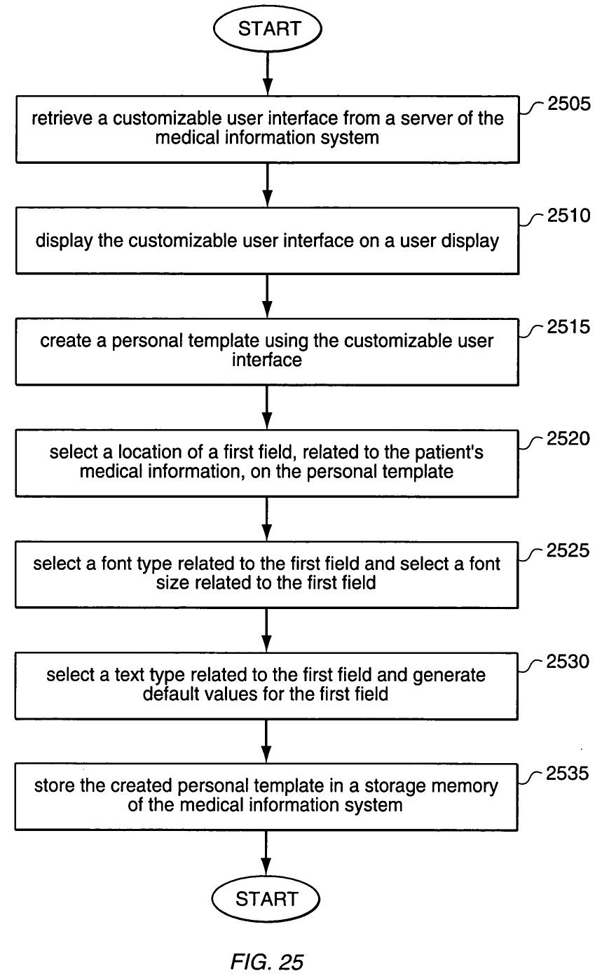

FIG. 25 is a flow chart illustrating a method in accordance with an embodiment of the present invention. As shown in box 2505, a user may retrieve a customizable user interface from a server of the medical information system. The customizable user interface may be in the form of a web page that may permit the user to customize the layout, content, look, font size, etc. related to the web page, for example. It is recognized that the interface may be any of the interfaces described herein and/or any other type of interfaces. The customizable user interface may be displayed on the user's display, as shown in box 2510. In an embodiment of the present invention, the user may create a personal template using the customizable user interface, as shown in 2515.

The personal template may be customized in accordance with personal preferences of the user. The user may create a personal template for each patient, if desired and may be used to enter the patient's information. As shown in box 2520, the user may select the location of a first field related to the patient's medical information, on the personal template. The user may select the font type, size, text type, and/or generate default values related to the first field, as shown in boxes 2525-2530. The user may store the created personal template in a storage memory of the medical information system, as shown in box 2535.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A medical information system for facilitating patient treatment by a clinician, comprising:
a server;
a memory coupled to the server; and
a customizable interface provided to a user's terminal by the server in response to a user's request, the customizable interface configured to allow the user to customize fields related to the patient's treatment to generate a personal interface template.

2. The system of claim 1, wherein the customizable interface comprises:
a customizable demographic information interface configured to allow the user to customize fields related to patient demographic information to generate a personal demographic information template.

3. The system of claim 2, further comprising:
a system repository residing in the memory to store the personal demographic information template, wherein the personal demographic information template is uploaded by the user to be accessible by a plurality of users of the medical information system.

4. The system of claim 1, wherein the customizable interface comprises:
a customizable medical history interface configured to allow the user to customize fields related to the patient's medical history information to generate a personal medical history template.

5. The system of claim 4, wherein the customizable interface comprises:
a system repository residing in the memory to store the personal medical history template, wherein the personal medical history template is uploaded by the user to be accessible by a plurality of users of the medical information system.

6. The system of claim 1, wherein the customizable interface comprises:
a customizable examination interface configured to allow the user to customize fields related to the patient's examination information to generate a personal examination template.

7. The system of claim 6, wherein the customizable interface comprises:
a system repository residing in the memory to store the personal examination template, wherein the personal examination template is uploaded by the user to be accessible by a plurality of users of the medical information system.

8. The system of claim 1, wherein the customizable interface comprises:
a diagnosis interface configured to allow the user to customize fields related to the patient's diagnosis information to generate a personal diagnosis template.

9. The system of claim 8, wherein the customizable interface comprises:
a system repository residing in the memory to store the personal diagnosis template, wherein the personal diagnosis template is uploaded by the user to be accessible by a plurality of users of the medical information system.

10. The system of claim 1, wherein the customizable interface comprises:
a medical procedure interface configured to allow the user to customize fields related to the medical procedure to generate a personal medical procedure template.

11. The system of claim 10, wherein the customizable interface comprises:
a system repository residing in the memory to store the personal medical procedure template, wherein the personal medical procedure template is uploaded by the user to be accessible by a plurality of users of the medical information system.

12. The system of claim 1, wherein the customizable interface comprises a web-page.

13. The system of claim 1, wherein at least one of a location, font type, font size, contents and text type related to the fields is customizable.

14. The system of claim 1, wherein at least one of a location, font type, font size, contents and text type related to the fields is customizable.

15. The system of claim 1, wherein the customizable interface to allow the user to generate default values for a plurality of fields related to the patient's treatment and to retrieve the generated default values from the memory.

16. The system of claim 1, wherein the customizable interface to allow the user to store information in a plurality of fields related to the patient's treatment and to retrieve the stored information from the memory.

17. The system of claim 1, wherein the personal template is used by the user to enter information for a patient.

18. A method for facilitating medical examination of a patient using a medical information system, comprising:
retrieving a customizable user interface from a server of the medical information system;
displaying the customizable user interface on a user display;
creating a personal template using the customizable user interface, comprising:
selecting a location of a first field, related to the patient's medical information, on the personal template;
selecting a font type related to the first field;
selecting a font size related to the first field;
selecting a text type related to the first field;
generating default values for the first field; and
storing the created personal template in a storage memory of the medical information system.

19. The method of claim 18, further comprising:
uploading the personal template to a user repository for future access by a user.

20. The method of claim 18, further comprising:
uploading the personal template to a system repository for access to a plurality of users of the medical information system.

21. The method of claim 18, further comprising:
retrieving the created personal template from the storage memory of the medical information system; and
populating the first field with the generated default values.

22. The method of claim 18, further comprising:
retrieving the created personal template from the storage memory of the medical information system;
entering text data in the first field of the personal template to generate a patient record;
storing the patient record in the storage memory of the medical information system.

23. The method of claim 22, further comprising:
downloading the patient record including the entered text data to the user's terminal.

24. The method of claim 22, further comprising:
storing the patient record to a local memory, wherein the patient record is stored as a portable document format file.

25. The method of claim 18, wherein creating a personal template using the customizable user interface comprises:
customizing a demographic information interface configured to allow the user to customize fields related to patient demographic information.

26. The method of claim 18, wherein creating a personal template using the customizable user interface comprises:
customizing a medical history interface configured to allow the user to customize fields related to the patient's medical history information.

27. The method of claim 18, wherein creating a personal template using the customizable user interface:
customizing an examination interface configured to allow the user to customize fields related to the patient's examination information.

28. The method of claim 18, wherein creating a personal template using the customizable user interface comprises:
customizing a diagnosis interface configured to allow the user to customize fields related to the patient's diagnosis information.

29. The method of claim 18, wherein creating a personal template using the customizable user interface comprises:
customizing a medical procedure interface configured to allow the user to customize fields related to the patient's medical procedure information.

30. The method of claim 18, wherein creating the personal template using the customizable user interface, comprising:
providing a drop down menu related to the first field, wherein the dropdown menu includes a plurality of selectable entries provided by the user.

31. The method of claim 30, wherein the selectable entries are related to at least on of a patient demographic data, patient examination data, patient procedure data, patient diagnosis data, patient medical history data, and patient medication data.

32. The method of claim 18, further comprising:
providing an system based entry auto-complete function drop down menu related to the first field, wherein the dropdown menu includes a list of selectable entries predetermined by the user.

33. The method of claim 33, furthering comprising:
storing the list of selectable entries in the server.

34. The method of claim 32, further comprising:
disabling a locally provided auto-complete function by the system based entry auto complete function.

35. A machine-readable medium having stored thereon a plurality of executable instructions to be executed by a processor to implement a method for facilitating medical examination of a patient using a medical information system, the method comprising:
retrieving a customizable user interface from a server of the medical information system;
displaying the customizable user interface on a user display;
creating a personal template using the customizable user interface, comprising:
selecting a location of a first field, related to the patient's medical information, on the personal template;
selecting a font type related to the first field;
selecting a font size related to the first field;
selecting a text type related to the first field;
generating default values for the first fields; and
storing the created personal template in a storage memory of the medical information system.

36. The machine-readable medium of claim 35, the method further comprises:
uploading the personal template to a user repository for future access by a user.

37. The machine-readable medium of claim 35, the method further comprises:
uploading the personal template to a system repository for access to a plurality of users of the medical information system.

38. The machine-readable medium of claim 35, the method further comprises:
retrieving the created personal template from the storage memory of the medical information system; and
populating the first field with the generated default values.

39. The machine-readable medium of claim 35, the method further comprises:
retrieving the created personal template from the storage memory of the medical information system;
entering text data in the first field of the personal template to generate a patient record;
storing the patient record in the storage memory of the medical information system.

40. A method for facilitating medical examination of a patient using a medical information system, comprising:
retrieving a customizable user interface from a server of the medical information system;
displaying the customizable user interface on a user display;
creating a personal template using the customizable user interface, comprising:
selecting a location of a first input field included in the personal template;
providing a system based entry auto-complete feature to enter data into the first input field, comprising:
generating a list of expected entries associated with the first input field, the list of expected entries to be compared with a user entry for a match; and
storing the created personal template in a storage memory of the medical information system.

41. The method of claim 40, further comprising:
providing an edit entry in the list of expected entries, wherein the edit entry permits a user to at least one of add, edit and delete entries in the list of expected entries.

42. The method of claim 41, further comprising:
disabling a local auto-complete function.
